(19) United States
(12) Patent Application Publication
(10) Pub. No.: US 2004/0219479 A1
(43) Pub. Date: Nov. 4, 2004

(54) Tool for installing a dental implant

(76) Inventors: Leo J. Malin, La Crosse, WI (US); Thomas J. Arendt, Norwalk, WI (US); Robert J. Harter, La Crosse, WI (US)

Correspondence Address: ROBERT J. HARTER, 4233 CLIFFSIDE DRIVE, LA CROSSE, WI, 54601, US

(21) Appl. No.: 10/429,086

(22) Filed: May 2, 2003

(51) Int. Cl. A61C 3/00

(52) U.S. Cl. 433/75

(57) ABSTRACT

A dental tool for guiding a drill or biopsy punch during a dental implant procedure includes a drill bushing pivotally attached to a bushing holder. The bushing holder, in turn, is attached to a surgical stent that fits a patient's teeth, gums, and/or jaw. The pivotal connection between the drill bushing and the bushing holder allows the angular orientation of the drill bushing to be adjusted, so the trajectory of the drill or biopsy punch can be aimed directly into the patient's jawbone. Once the drill bushing is properly oriented, the bushing is bonded to the bushing holder to prevent further movement between the bushing and the holder.

### BACKGROUND OF THE INVENTION

1. Field of the Invention

The subject invention generally pertains to dental implants and more specifically to a tool for installing them.

2. Description of Related Art

Various dental implant methods and devices have been developed for replacing one or more missing teeth in a person's jaw with prosthetic teeth. For many prosthetic teeth, a final product comprises three basic components: an implant, an abutment, and a crown. The crown is the exposed portion of the prosthesis that resembles one or more teeth. The implant is an anchor that becomes attached to the jawbone, and the abutment couples the crown to the implant.

Typical implant methods involve a series of procedures extending over several months. In some cases, for instance, the process involves first, cutting the gum tissue in the area of the missing tooth and pulling the tissue back to expose the jawbone; second, drilling a hole into the bone; third, installing an anchoring member or implant into the hole; fourth, attaching a cover screw to the implant and stitching the gum tissue back together; fifth, waiting up to several months to allow the gum tissue to heal over the cover screw and to allow the bone to grow onto the implant; sixth, cutting a small round hole in the gum tissue to remove the cover screw and expose the implant; seventh, attaching a healing cap to the implant; waiting another extended period to allow the gum tissue to heal around the healing cap; eighth, replacing the healing cap with an abutment; and ninth, attaching a crown (e.g., an individual prosthetic tooth, bridge, denture, etc.) to the abutment.

An implant process can be improved with the aid of drill guide bushings and tomography as disclosed in PCT Publication WO 99/26540 by Klein et al. (specifically incorporated by reference herein). The Klein method involves taking a CT scan (computed tomography scan) of a patient wearing a surgical template that overlays the patient's teeth. The surgical template preferably has three fiducial markers that are detected by the CT scan. After taking the tomographical scan, the surgical template is removed from the patient's mouth and placed over a model of the patient's jaw. The model jaw with the surgical template is loaded onto a computer-driven milling machine. With the aid of the CT scan data and the three fiducial markers, the milling machine accurately drills a hole into the surgical template. The template, now with an accurately drilled hole, is returned to the patient's mouth, so the hole in the template can then be used as a drill guide when drilling into the patient's actual jawbone. Drawbacks of such a method include its overall complexity and the expense of the computer-driven milling machine.

Another implant method and related device is disclosed by Fenick in U.S. Pat. Nos. 5,015,183 and 5,133,660, which are specifically incorporated by reference herein. Fenick uses X-rays to help identify a drill bit trajectory and uses drill guide bushings to help guide the drill bit. The Fenick system creates a radiology stent that includes a radially opaque grid. The stent, without any drill bushings, is X-rayed while in the patient's mouth. The stent is then placed over a model of the patient's jaw where the grid provides a frame of reference that helps in manually positioning a drill bit relative to the model jaw. A hole is drilled into the model, and the resulting hole helps align a drill bushing relative to the model. Next, a cast is created over the model to capture the drill bushing. The cast, with the drill bushing, is then placed in the patient's mouth to help guide the drill bit that drills a hole into the patient's jawbone. With the Fenick system, some positional accuracy may be sacrificed because the drill bushing is aligned to a model rather than being aligned directly to the patient's actual jaw.

Various other examples of dental implant methods and devices are disclosed in U.S. Pat. Nos. 6,283,753; 5,718,579; 5,613,852; 5,064,374; 5,015,186; RE37,646; 3,748,739; 5,350,297; 6,488,502; 4,998,881; all of which are specifically incorporated by reference herein. Additional examples of dental implant methods and devices are disclosed in U.S. Patent Application Publication US 2002/0182567 and European Patent Application 0437031 A1; both of which are specifically incorporated by reference herein.

Of the aforementioned patents and applications, U.S. Pat. No. 5,718,579, by Kennedy, is of particular interest. In the '579 patent, Kennedy discloses a method of adjusting the angular position of a drill bushing that is press-fitted into a hole in a splint. A tool helps in prying the bushing to a proper orientation. The Kennedy system, however, has a few drawbacks. First, the pivotal point of the bushing is adjacent to the surface of the gum tissue, so as one end of the drill bushing is aimed toward the jawbone, the opposite end may point away from the desired center point of the prosthetic tooth. Thus, in some cases, an angled implant/abutment (e.g., FIG. 26B of U.S. Pat. No. 6,283,753) may be needed to obtain a prosthetic tooth with a centrally located abutment. Such an angled implant/abutment may have been avoided if a proper drill trajectory had been established in the first place.

A second problem with the Kennedy system pertains to the drill bushing being press-fitted into a simple hole in a splint. When a cylinder, such as a drill bushing, is press-fitted into a cylindrical hole, the bushing and hole will naturally urge themselves into coaxial alignment with each other. Of course, the bushing can be forced out of alignment to some extent, but the degree of angular adjustment is significantly limited.

Consequently, a need exists for a better way to adjust the angular position of a drill bushing used in a dental implant process.

### SUMMARY OF THE INVENTION

To provide a better way of adjusting the angular position of a drill bushing used in a dental implant process, it is an object of some embodiments of the invention to provide a tool that includes both a drill bushing and a bushing holder, wherein the drill bushing can pivot within the bushing holder.

Another object of some embodiments is to attach the bushing holder to a sent that fits a patient's jaw.

Another object of some embodiments is to use a ball-and-socket joint to pivotly attach a drill bushing to a bushing holder.

Another object of some embodiments is to provide the ball-and-socket joint with an interference fit, so the drill bushing tends to stay where it is placed.

Another object of some embodiments is to provide a metal drill bushing with a plastic or polymeric spherical sleeve, wherein the sleeve serves as the ball portion of the ball-and-socket joint.

Another object of some embodiments is to bond the drill bushing to the bushing holder.

Another object of some embodiments is to bond the bushing holder to the stent.

Another object of some embodiments is to use the drill bushing to guide a drill bit into a jawbone.

Another object of some embodiments is to use the drill bushing to guide a biopsy punch.

Another object of some embodiments is to form a stent about a plug to create a cavity in the stent, wherein the cavity provides a place to insert the bushing holder.

Another object of some embodiments is to use a plug that includes an irregularity (e.g., a dimple or protrusion) for creating a dimple in the stent. The dimple in the stent can then be used as a “center punch mark,” which later helps in creating a properly located hole in the stent.

Another object of some embodiments is to provide a drill bushing with a ball-and-socket feature by plastic injection molding a spherical sleeve about a metal bushing, wherein the bushing is held within a mold cavity during the plastic injection molding process.

One or more of these and other objects of the invention are provided by a dental tool that includes a drill bushing pivotally attached to a bushing holder. The bushing holder, in turn, is attached to a stent that fits a patient's jaw.

### BRIEF DESCRIPTION OF THE DRAWING

Figure is a cross-sectional view of a dental tool.

FIG. 2 is a perspective view of a jaw model.

FIG. 3 is a perspective view of a stent being made.

FIG. 4 is a perspective view of a stent.

FIG. 5 is a perspective view of a dental tool being attached to a stent.

FIG. 6 is a cross-sectional view of a dental tool.

FIG. 7 is a cross-sectional view of a dental tool being assembled.

FIG. 8 is a cross-sectional view of a central tube installed in a plastic injection mold.

FIG. 9 is a cross-sectional view similar to FIG. 9 but showing the plastic having been injected into the mold cavity.

FIG. 10 is a cross-sectional view showing the mold being opened to remove the drill bushing.

### DESCRIPTION OF THE PREFERRED EMBODIMENT

Referring to FIG. 1, installing a dental implant to replace a missing tooth typically involves cutting away a portion of a patient's gum tissue 10 and drilling a hole into the patient's jawbone 12. The implant is then inserted into the hole and anchored to the bone.

To help guide a cutting tool 14, such as a drill bit 16 for the bone or a biopsy punch 18 for the gum tissue, a dental tool 20 can be placed in the patient's mouth in the area of the missing tooth. Dental tool 20 includes a drill bushing 22 that is pivotally attached to a bushing holder 24. A stent 26 can help hold tool 20 in the proper location of the missing tooth.

The multiple steps of making stent 26, attaching tool 20 to the stent, adjusting the angular orientation of drill bushing 22, and locking drill bushing 22 in place can be carried out as follows.

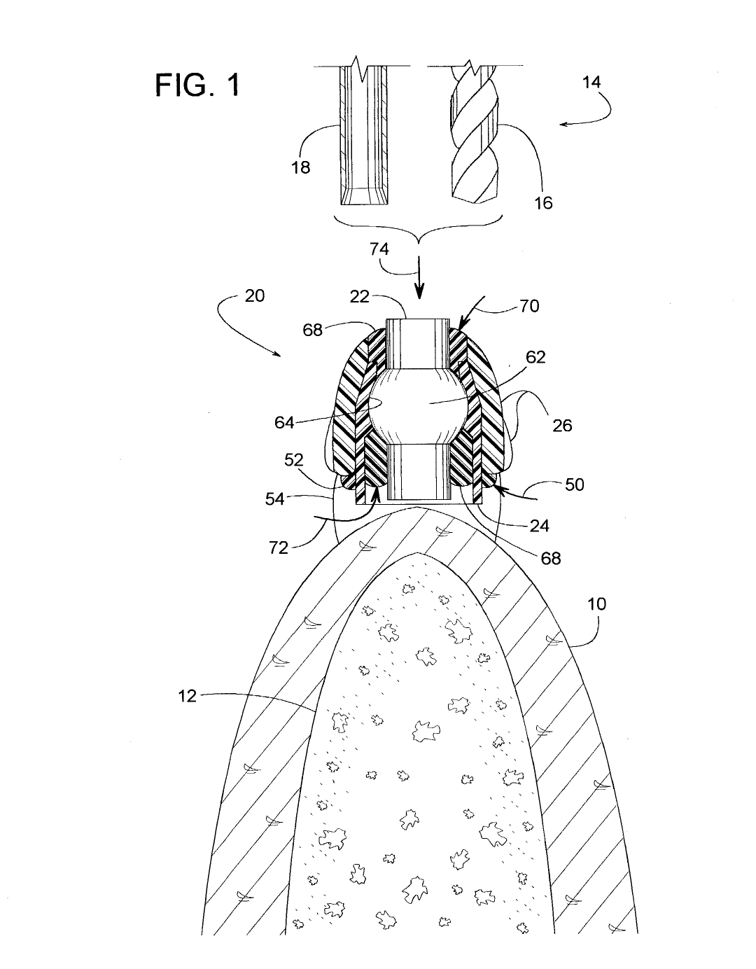

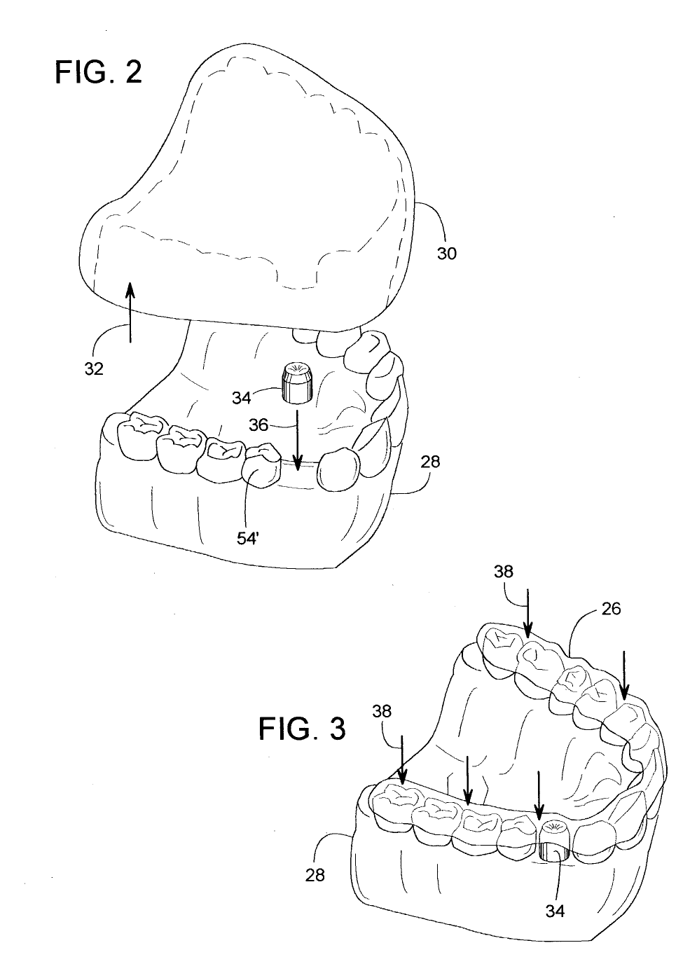

FIG. 2 shows a cast model 28 of the patient's jaw being produced. The term, “jaw” encompasses a patient's upper or lower jawbone, gums, and/or teeth. First, a pliable mold 30 is made of the patient's jaw, and then a casting material is poured into the mold. After the casting material sets to produce jaw model 28, the pliable mold 30 is removed as indicated by arrow 32. Such a casting and mold making process is well known to those skilled in the art.

Next, an appropriately sized plug 34 can be attached to jaw model 28 in the area of the missing tooth. Arrow 36 illustrates this step in FIG. 2. Plug 34 can be attached to model 28 in various ways including, but not limited to, bonding with wax, bonding with cement, gluing, attaching with a mechanical fastener, etc.

FIG. 3 shows surgical stent 26 being made by vacuum-forming an acrylic sheet over model 28 and plug 34; however, it should be appreciated by those skilled in the art that there are other ways of making a surgical stent that are well within the scope of the invention. Arrows 38 of FIG. 3 illustrate the step of vacuum-forming or otherwise producing stent 26 in a conventional manner.

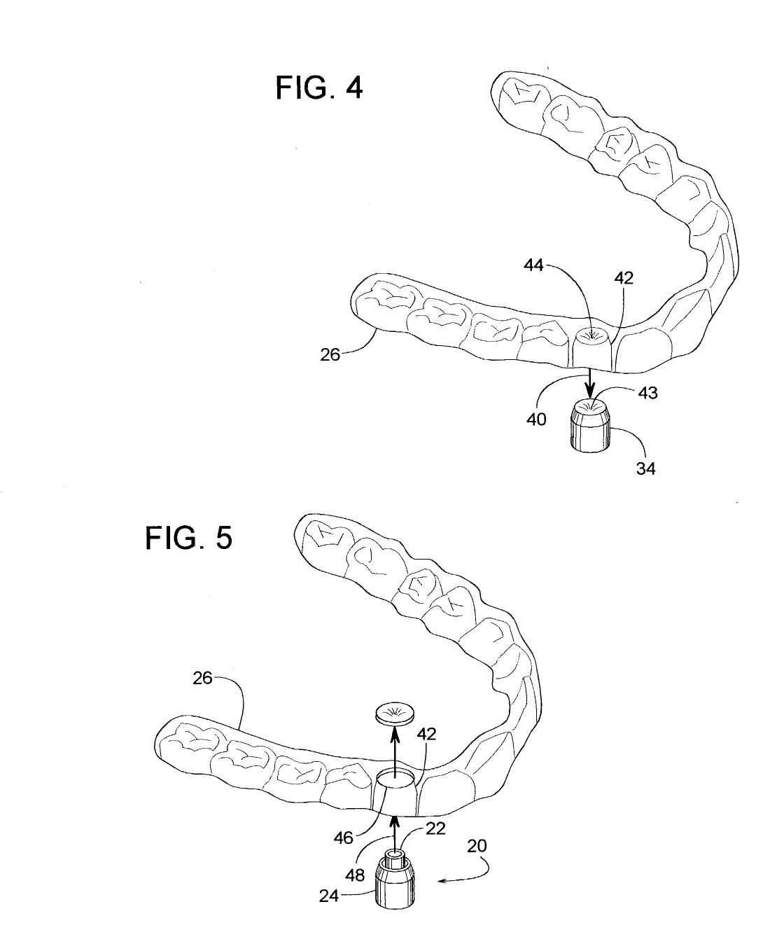

Referring to FIG. 4, once stent 26 is formed, the stent is removed from model jaw 28. Plug 34 stays affixed to model 28, so stent 26 and plug 34 separate as indicated by arrow 40. The separation of plug 34 and stent 26 leaves a cavity 42 in stent 26.

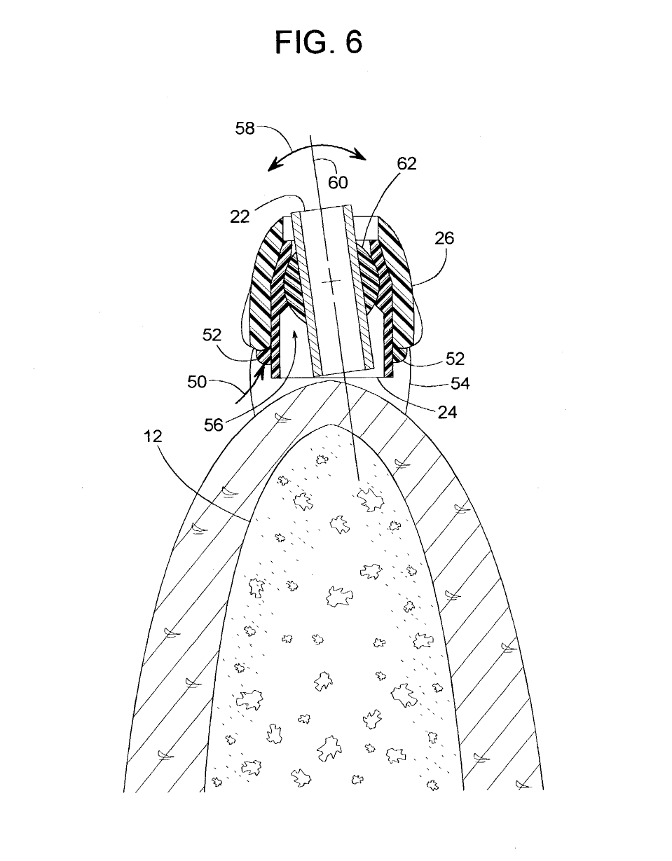

Plug 34 preferably includes an irregularity 43 (e.g., a dimple, recess, protrusion, etc.) that forms a dimple 44 in stent 26. If irregularity 43 is a recess, then dimple 44 is concave at the topside of stent 26, as shown in FIG. 4. However, if irregularity 43 is a small peak or protrusion pointed upward, then the resulting concave surface of dimple 44 will face in the opposite direction, or downward. Regardless of whether the concave surface of dimple 44 faces upward or downward, dimple 44 in stent 26 serves as a “center punch mark,” which helps in creating a properly located hole 46 in stent 26, as shown in FIG. 5. Hole 46 can be made using a drill, punch, or other conventional tool. Once hole 46 is created, dental tool 20 is inserted into cavity 42 of stent 26. Arrow 48 of FIG. 5 illustrates the step of inserting tool 20 into cavity 42, and arrow 50 of FIG. 6 represents bonding material 52 bonding bushing holder 24 to stent 26. Bonding material 52 can be any appropriate adhesive or cement that can affix bushing holder 24 to stent 26.

After attaching bushing holder 24 to stent 26, the stent can be placed in the patient's mouth with the stent engaging various teeth and/or the patient's gum tissue. FIG. 6 shows stent 26 overlaying an actual tooth 54, which corresponds to a cast tooth 54′ of model 28.

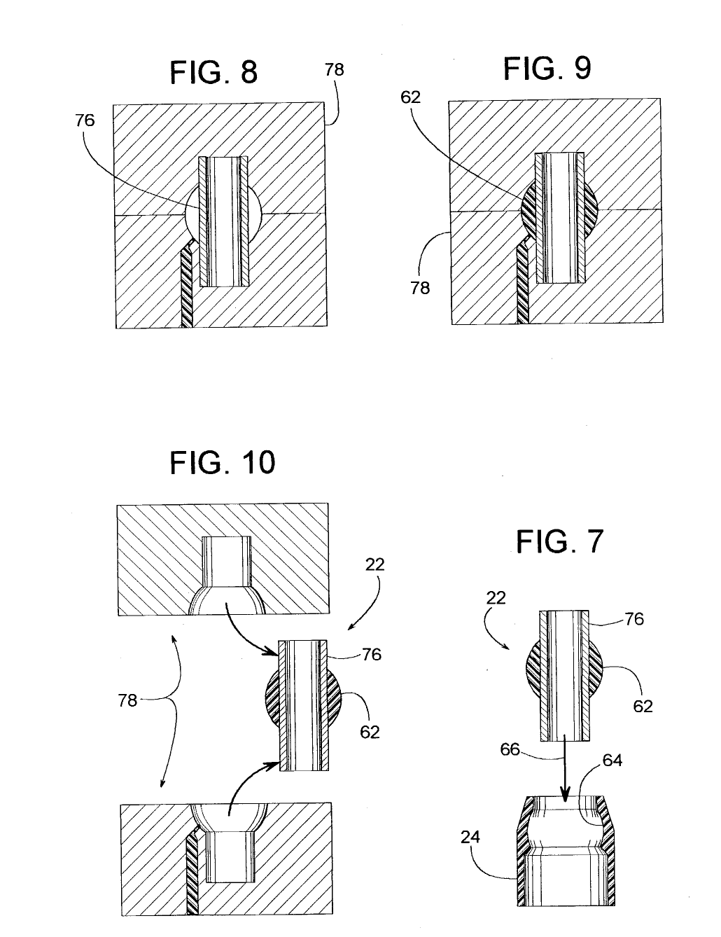

Although bushing holder 24 is now generally fixed relative to the patient's jaw, a ball-and-socket joint 56 between drill bushing 22 and bushing holder 24 allows some pivotal adjustment of drill bushing 22. The adjustment, represented by arrow 58, allows a centerline 60 or drill bit trajectory of bushing 22 to be aimed directly into jawbone 12. FIG. 6 shows drill bushing 22 being misaligned with jawbone 12, but FIG. 1 shows bushing 22 squarely aimed into jawbone 12. Ball-and-socket joint 56 includes a generally spherical sleeve 62 that is press-fitted into a mating spherical cavity 64 in bushing holder 24 as shown in FIG. 7. Arrow 66 of FIG. 7 represents bushing 22 being inserted into holder 24. An interference fit preferably exists between spherical sleeve 62 and cavity 64, so drill bushing 22 tends to stay where it is placed within holder 24.

Once drill bushing 22 is aiming in the right direction, as shown in FIG. 1, the bushing's position can be held in place by having a bonding material 68 bond bushing 22 to holder 24. Arrows 70 and 72 of FIG. 1 illustrate the step of bonding bushing 22 to holder 24. With stent 26 held in place relative to jawbone 12 and with drill bushing 22 being held fixed relative to holder 24 and stent 26, drill bit 16 or biopsy punch 18 can be inserted into bushing 22. Arrow 74 illustrates the step of inserting biopsy punch 18 into bushing 22 to remove a round section of gum tissue. Arrow 74 also illustrates the step of inserting drill bit 16 into bushing 22 to drill a hole into jawbone 12. Once the hole is drilled into jawbone 12, the rest of the implant process can be performed in a conventional manner.

FIGS. 8, 9 and 10 illustrate how in some embodiments drill bushing 22 can be produced by plastic injection molding spherical sleeve 62 about a central tube 76 of drill bushing 22. In some cases, tube 76 is made of metal, and sleeve 62 is made of plastic. FIG. 8 shows tube 76 inserted into the cavity of a two-piece plastic injection mold 78. FIG. 9 shows the plastic being injected around tube 76 to create spherical sleeve 62. FIG. 10 shows the completed drill bushing 22 being removed from mold 78.

Although drill bushing 22 is shown as a two-piece part, a similar bushing can be machined or molded as a unitary piece. The drill bushing, including the spherical sleeve portion, can be made entirely of metal or entirely of plastic.

Although the invention is described with reference to a preferred embodiment, it should be appreciated by those skilled in the art that various modifications are well within the scope of the invention. In some cases, for example, the surgical stent is produced without using plug 34. In such cases, the cavity, otherwise created by plug 34, is instead filled with a solid plastic material. A hole can then be drilled into that solid plastic material to provide a bore or cavity into which tool 20 can be inserted and bonded thereto. Therefore, the scope of the invention is to be determined by reference to the claims that follow.

We claim:

1. A dental tool for guiding a cutting tool relative to a jaw of a patient, comprising:
a stent adapted to engage the jaw;
a bushing holder attached to the stent; and
a drill bushing adapted to receive the cutting tool and being pivotally attached to the bushing holder.

2. The dental tool of claim 1, wherein the bushing holder and the drill bushing creates a ball-and-socket joint therebetween.

3. The dental tool of claim 2, wherein the ball-and-socket joint provides an interference fit between the drill bushing and the bushing holder.

4. The dental tool of claim 1, wherein the drill bushing comprises a substantially spherical sleeve made of plastic disposed about a central tube made of metal.

5. The dental tool of claim 1, further comprising a bonding material extending from the bushing holder to the stent.

6. The dental tool of claim 1, further comprising a bonding material extending from the bushing holder to the drill bushing.

7. The dental tool of claim 1, wherein the cutting tool is a drill bit.

8. The dental tool of claim 1, wherein the cutting tool is a cylindrical biopsy punch.

9. A dental tool for guiding a cutting tool relative to a jaw of a patient, comprising:
a bushing holder;
a drill bushing adapted to receive the cutting tool; and
a ball-and-socket joint creating an interference fit between the bushing holder and the drill bushing, wherein the drill bushing is pivotally coupled to the bushing holder.

10. The dental tool of claim 9, wherein the drill bushing comprises a substantially spherical sleeve made of plastic disposed about a central tube made of metal.

11. The dental tool of claim 9, further comprising a bonding material extending from the bushing holder to the drill bushing.

12. A dental tool method for guiding a cutting tool relative to a jaw of a patient, comprising, comprising:
creating a stent adapted to engage the jaw;
attaching a bushing holder to the stent;
attaching a drill bushing to the bushing holder; and
pivoting the drill bushing relative to the bushing holder.

13. The dental tool method of claim 12, further comprising bonding the bushing holder to the stent.

14. The dental tool method of claim 12, further comprising gluing the drill bushing to the bushing holder.

15. The dental tool method of claim 12, further comprising creating a cavity in the stent; and inserting the bushing holder into the cavity.

16. The dental tool method of claim 15, further comprising:
creating a model jaw;
attaching a plug to the model jaw;
forming the stent about the plug; and
removing the plug from the stent, thereby creating the cavity.

17. The dental tool method of claim 15, wherein the cavity is created by forming the stent about a plug, wherein the plug includes an irregularity that creates a dimple in the stent upon forming the stent about the plug.

18. The dental tool method of claim 17, further comprising creating a hole at the dimple in the stent.

19. The dental tool method of claim 12, further comprising creating a ball-and-socket joint between the drill bushing and the bushing holder.

20. The dental tool method of claim 19, wherein drill bushing includes a central tube, and the step of creating a ball-and-socket joint between the drill bushing and the bushing holder involves plastic injection molding a spherical sleeve around the central tube.
